(19) United States
(12) Patent Application Publication
(10) Pub. No.: US 2014/0140744 A1
(43) Pub. Date: May 22, 2014

(54) AUTOMATIC DOCUMENT FEEDER, IMAGE SCANNING DEVICE, AND IMAGE FORMING APPARATUS

(71) Applicants: Takeshi AKAI, Kanagawa (JP); Takashi FUJII, Kanagawa (JP); Satoshi SAITO, Kanagawa (JP); Hiroshi KUBO, Kanagawa (JP); Ikuhisa OKAMOTO, Kanagawa (JP); Shinya KITAOKA, Kanagawa (JP); Takehisa SHIMAZU, Kanagawa (JP); Kenichiro MORITA, Tokyo (JP); Yoshito SUZUKI, Kanagawa (JP); Takuma ARIGA, Kanagawa (JP); Jun YAMADA, Kanagawa (JP); Kenji HAYASAKA, Kanagawa (JP); Akihito KAMEDA, Kanagawa (JP); Hiroaki UTAGAWA, Kanagawa (JP); Fumiyuki HEISHI, Kanagawa (JP)

(72) Inventors: Takeshi AKAI, Kanagawa (JP); Takashi FUJII, Kanagawa (JP); Satoshi SAITO, Kanagawa (JP); Hiroshi KUBO, Kanagawa (JP); Ikuhisa OKAMOTO, Kanagawa (JP); Shinya KITAOKA, Kanagawa (JP); Takehisa SHIMAZU, Kanagawa (JP); Kenichiro MORITA, Tokyo (JP); Yoshito SUZUKI, Kanagawa (JP); Takuma ARIGA, Kanagawa (JP); Jun YAMADA, Kanagawa (JP); Kenji HAYASAKA, Kanagawa (JP); Akihito KAMEDA, Kanagawa (JP); Hiroaki UTAGAWA, Kanagawa (JP); Fumiyuki HEISHI, Kanagawa (JP)

(73) Assignee: Ricoh Company, Limited, Tokyo (JP)

(21) Appl. No.: 14/080,961

(22) Filed: Nov. 15, 2013

(30) Foreign Application Priority Data
Nov. 16, 2012 (JP) 2012-252246

(51) Int. Cl. G03G 15/00

(52) U.S. Cl. CPC G03G 15/607
USPC 399/371

(57) ABSTRACT

An automatic document feeder includes a document stack unit; a conveying unit configured to separate a document from the documents stacked on the document stack unit and convey the document to a scanning position through a conveying path; document detecting units configured to detect the document; an upstream document detecting unit configured to detect the document, the upstream document detecting unit being arranged in the conveying path at an uppermost stream in a document conveying direction with respect to the document detecting units; and a determining unit configured to determine a passage of a trailing end of the document at positions of the document detecting units and the upstream document detecting unit and determine a presence of a hole on the document, based on the detection results. A detection range of the upstream document detecting unit is set to be wider than detection ranges of the document detecting units.

### CROSS-REFERENCE TO RELATED APPLICATION

The present application claims priority to and incorporates by reference the entire contents of Japanese Patent Application No. 2012-252246 filed in Japan on Nov. 16, 2012.

### BACKGROUND OF THE INVENTION

1. Field of the Invention

The present invention relates to an automatic document feeder, an image scanning device, and an image forming apparatus.

2. Description of the Related Art

Conventionally, a technique as an automatic document feeder of this type has been known, in which a reflection of light emitted from an optical sensor is utilized to detect end parts of a document, i.e., a leading end and a trailing end, in a conveying direction, an ON/OFF state of an optical sensor around an entrance of a conveying path is monitored to differentiate the trailing end of the document and a hole on the document, and a start-up timing of driving units of a scanning unit and a conveying unit and a timing of starting to convey a next document are controlled depending on a result of the differentiation. More detailed information of the conventional technique can be obtained in Japanese Patent Application Laid-open No. H9-222752, for example. In the technique disclosed in Japanese Patent Application Laid-open No. H9-222752, a plurality of optical sensors are provided on the conveying path to differentiate the trailing end of the document and a hole on the document in each of the optical sensors.

However, since the trailing end of the document and the hole on the document are differentiated not only in an optical sensor around the entrance of the conveying path but also in an optical sensor locating at a downstream side from the optical sensor around the entrance and a processing time required for differentiation between the trailing end of the document and the hole on the document thereby becomes long in the technique disclosed in Japanese Patent Application Laid-open No. H9-222752, a restart of conveying the document which is stopped due to a skew correction for example is to be performed late in timing, which results in a problem that an interval in conveying the documents becomes long.

Therefore, there is a need for an automatic document feeder, an image scanning device, and an image forming apparatus capable of reducing a processing time required for the determination between the trailing end of the document and the hole on the document and of shortening an interval in conveying documents.

### SUMMARY OF THE INVENTION

It is an object of the present invention to at least partially solve the problems in the conventional technology.

According to an embodiment, there is provided an automatic document feeder that includes a document stack unit on which documents are stacked; a conveying unit configured to separate a document from the documents stacked on the document stack unit and convey the document to a scanning position through a conveying path; a plurality of document detecting units configured to detect the document, the document detecting units being arranged in the conveying path; an upstream document detecting unit configured to detect the document, the upstream document detecting unit being arranged in the conveying path at an uppermost stream in a document conveying direction with respect to the document detecting units; and a determining unit configured to determine a passage of a trailing end of the document at positions where the document detecting units and the upstream document detecting unit are provided and determine a presence of a hole on the document, based on results of detection by the document detecting units and the upstream document detecting unit. A detection range of the upstream document detecting unit is set to be wider than detection ranges of the document detecting units. The upstream document detecting unit and the document detecting units are arranged so that all the detection ranges of the document detecting units are included in the detection range of the upstream document detecting unit in a direction perpendicular to the document conveying direction. The determining unit is configured to determine the passage of the trailing end of the document without determining the presence of the hole on the document when the determining unit determines that there is no hole on the document based on the detection result of the upstream document detecting unit.

According to another embodiment, there is provided an image scanning device that includes the automatic document feeder according to the above embodiment.

According to still another embodiment, there is provided an image forming apparatus that includes the automatic document feeder according to the above embodiment.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 shows an overview of a configuration of an automatic document feeder and an image forming apparatus provided with the automatic document feeder according to a first embodiment;

FIG. 2 shows a configuration of the automatic document feeder according to the first embodiment;

FIG. 3 is a block diagram of a control system of the automatic document feeder according to the first embodiment;

FIG. 4 is a block diagram of a configuration of an image scanning unit of the automatic document feeder according to the first embodiment of the present invention;

FIGS. 5A and 5B each show a configuration of a reflective photo sensor used in the automatic document feeder according to the first embodiment;

FIGS. 6A and 6B are top views showing an arrangement of document detection sensors of the automatic document feeder according to the first embodiment;

FIG. 7 is a flowchart of an operation regarding a document hole detection in the automatic document feeder according to the first embodiment;

FIG. 8 is a top view showing an arrangement of document detection sensors of an automatic document feeder according to a second embodiment;

FIG. 9 is a flowchart of an operation regarding a document hole detection in the automatic document feeder according to the second embodiment;

FIG. 10 is a top view showing an arrangement of document detection sensors of an automatic document feeder according to a third embodiment;

FIG. 11 is a flowchart of an operation regarding a document hole detection in the automatic document feeder according to the third embodiment;

FIG. 12 shows a document set reference position on a one-side reference basis in an automatic document feeder according to a fourth embodiment; and

FIG. 13 shows a document set reference position on a center-reference basis in the automatic document feeder according to the fourth embodiment of the present invention.

### DETAILED DESCRIPTION OF THE PREFERRED EMBODIMENTS

### First Embodiment

A first embodiment of the present invention will be explained below with reference to the accompanying drawings.

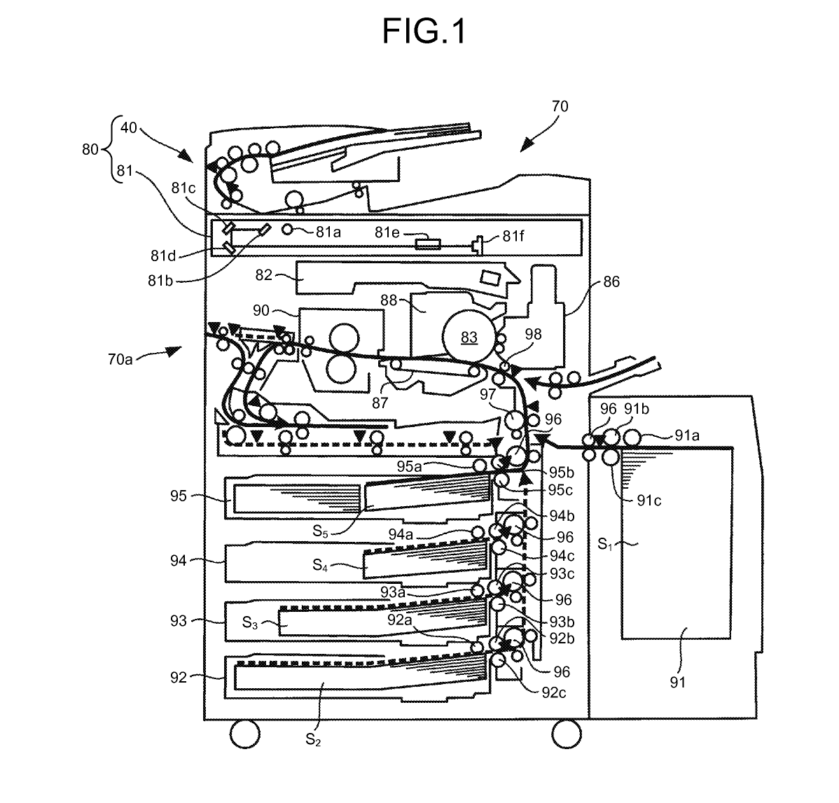

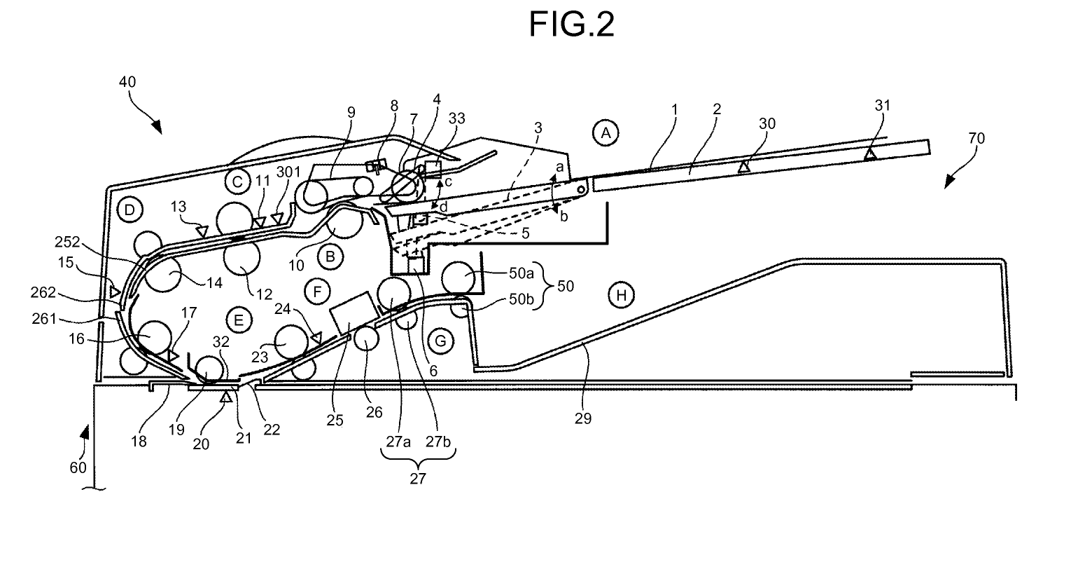

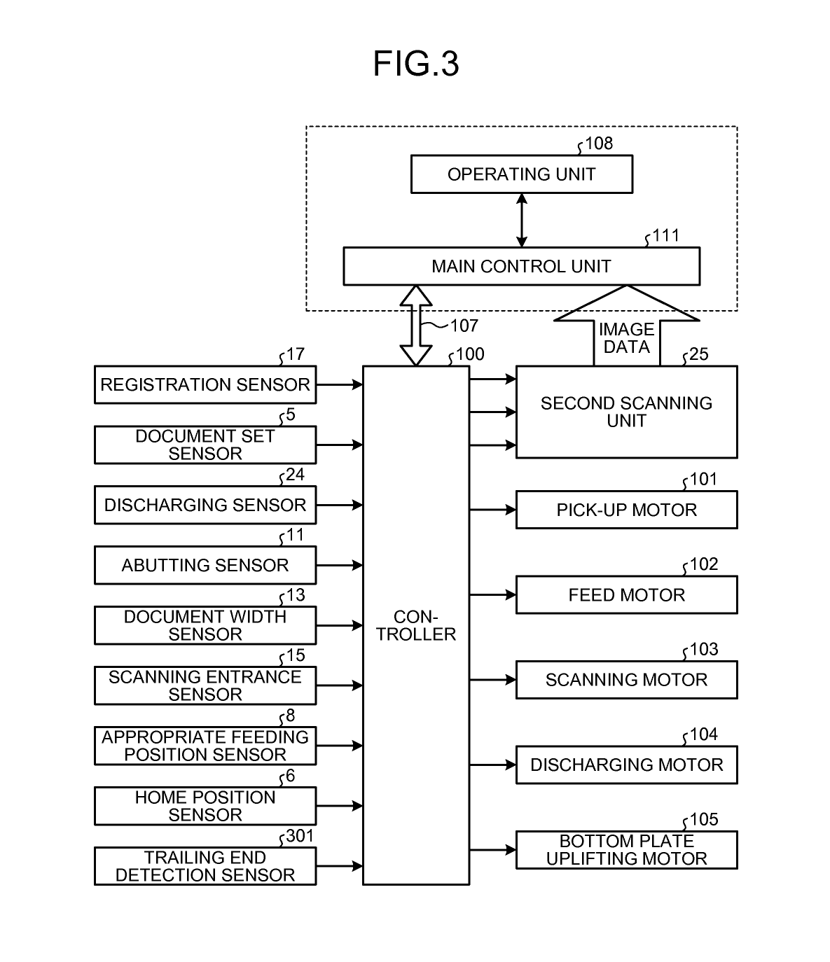

FIG. 1 shows an overview of a configuration of an automatic document feeder and an image forming apparatus provided with the automatic document feeder according to a first embodiment. FIG. 2 shows a configuration of the automatic document feeder according to the first embodiment. FIG. 3 is a block diagram of a control system of the automatic document feeder according to the first embodiment. The image forming apparatus includes functions of a copying machine, a facsimile, a multi-function peripheral provided with a copying function and a facsimile function, and the like.

The configuration will be explained, first.

As shown in FIGS. 1 and 2, an image forming apparatus 70 is provided with an automatic document feeder 40 that conveys a document and an image forming apparatus main body 70a that scans a document and forms an image on a sheet of transfer paper. The automatic document feeder 40 is provided in such a manner as to be freely opened and closed with respect to the image forming apparatus main body 70a via a hinge mechanism not shown.

An image scanning unit 81 is provided in the image forming apparatus main body 70a and image information scanned by the image scanning unit 81 is configured to be exposed by a writing unit 82 onto a photosensitive drum 83. The automatic document feeder 40 and the image scanning unit 81 in combination constitute the image scanning device 80.

The image scanning unit 81 is provided with a light source 81a that illuminates a document on an exposure glass 22 or on a slit glass 21, first, second, and third mirrors 81b, 81c, and 81d that each reflect a light reflected from the document, a lens 81e that focuses the light reflected from the third mirror 81d on a CCD image sensor 81f into an image, and the CCD image sensor 81f that converts the light focused by the lens 81e into an electric signal.

The light source 81a and the first mirror 81b are attached to a not-shown first running body and the second mirror 81c and the third mirror 81d are attached to a second running body, the first and the second running bodies being configured to move along the exposure glass 22 and the slit glass 21.

The first and the second running bodies are controlled to move under the exposure glass 22 in the horizontal direction in FIG. 1 in scanning the document placed on the exposure glass 22 and to stop under the slit glass 21 in scanning the document passing through the slit glass 21.

The writing unit 82 is configured to radiate a laser beam which is optically modulated depending on image information scanned by the image scanning unit 81 to expose a surface of the charged photosensitive drum 83 with the laser beam.

Around the photosensitive drum 83, a developing device 86; a transfer belt 87; a cleaning device 88; and not-shown charging device and neutralization device, which constitute an image forming unit together with the photosensitive drum 83, are provided. The charging device is configured to charge the surface of the photosensitive drum at a constant potential by controlling, by a grid, a corona discharge of a positive charge in the dark.

The writing unit 82 radiates a laser diode including the image information on the photosensitive drum 83 which is charted at a constant potential, eliminates a negative charge on the photosensitive drum 83, and forms an electrostatic latent image.

The developing device 86 attaches a negatively charged toner to a part from which electricity is eliminated on the photosensitive drum 83 to form a visible image. A positive bias is applied to the transfer belt 87, which is configured to transfer the negatively charged visible image onto a sheet of transfer paper (blank paper) as a recording medium and convey the paper.

The cleaning device 88 is provided with a cleaning blade and configured to scratch and remove the toner remaining on the photosensitive drum 83. The neutralization device eliminates a residual charge of the photosensitive drum 83 by lighting an internal LED and makes preparations for forming a new image on a next sheet of transfer paper.

The transfer paper on which an image is formed through the above-described processes is conveyed to a fixing device 90, which fixes the toner image.

The image forming apparatus main body 70a is provided with storage cassettes 91 to 95 storing accumulated sheets of transfer paper different from each other in size. The sheets of transfer paper stored in the storage cassettes 91 to 95 are fed by calling rollers 91a to 95a and separated by paper feeding rollers 91b to 95b rotating in a conveying direction and by reverse rollers 91c to 95c which slide in contact with the paper feeding rollers 91b to 95b and rotate in a separating direction.

The separated sheet of transfer paper is conveyed to a pair of registration rollers 98 via a pair of relay rollers 96 and 97 and conveyed by the registration roller 98 when the opportunity comes into a conveying path between the photosensitive drum 83 and the transfer belt 87.

As shown in FIG. 2, the automatic document feeder 40 is provided with a document table 2 on which a document bundle 1 including a plurality of documents is placed with a document face looking upward, a pick-up roller 7 that conveys an uppermost document from the document bundle 1 placed on the document table 2, and a paper feeding belt 9 and a reverse roller 10 that separate the document conveyed by the pick-up roller 7.

The automatic document feeder 40 is provided with a pull-out roller 12, an intermediate roller 14, and a scanning entrance roller 16 that convey the separated one document to the vicinity of the slit glass 21 of the image forming apparatus main body 70a, and a scanning roller 19 that conveys the document conveyed to the vicinity of the slit glass 21 with the document in contact with the slit glass 21.

The automatic document feeder 40 is provided with a scanning exit roller 23 that further conveys the document which is scanned at a scanning position 20 of the slit glass 21, a pair of discharging rollers 50 that discharge the document conveyed by the scanning exit roller 23, and a discharge tray 29 on which the discharged document is placed.

The intermediate roller 14 conveys the document conveyed by the pull-out roller 12 into a turn section D and a plurality of intermediate rollers 14 are arranged in straight rows along a direction perpendicular to the document conveying direction at an upstream part in the document conveying direction in the turn section D.

The scanning entrance roller 16 conveys the document conveyed from the turn section D to the vicinity of the slit glass 21 and a plurality of scanning entrance rollers 16 are arranged in straight rows along the direction perpendicular to the document conveying direction at a downstream part in the document conveying direction in the turn section D.

The document placed on the document table 2 is configured to pass through each section of the conveying path until discharged to the discharge tray 29. The conveying path includes a document set section A on which the document bundle 1 is placed, a separating and feeding section B which separates and feeds one document from the placed document bundle 1, and a registration section C which comes to be in direct contact with a surface of the fed document, lays out the document, and pulls out and conveys the laid-out document.

The conveying path also includes the turn section D which turns a front surface of the document to be conveyed down and conveys the document, a first scan conveying section E which scans the front surface of the document from underneath, a second scan conveying section F that scans a rear surface of the document, a discharging section which discharges the document whose scanning on the front and the rear sides are completed to an outside, and a stack section H on which the discharged document is placed.

Here, the front surface of the document indicates a surface which looks upward on the document table 2 and is scanned in the first scan conveying section E, and the rear surface of the document indicates a surface which looks downward on the document table 2 and is scanned in the second scan conveying section F.

The turn section D constitutes a part of the document conveying path from the document table 2 to the discharge tray 29 and is a curving path which curves in such a manner as to change (reverse) the conveying direction of the document approximately by 180 degrees. In an outward of the curvature of the turn section D, outer guiding members 261 and 262 that guide the document in conveying in the turn section D are arranged and in an inward of the curvature of the turn section D, an inner guiding member 252 that guides the document in conveying in the turn section D is arranged.

As shown in FIG. 3, the automatic document feeder 40 is provided with a controller 100 that controls an entirety of the automatic document feeder 40. The automatic document feeder 40 is also provided, as sensors that input signals to the controller 100, with a registration sensor 17, a document set sensor 5, a discharging sensor 24, and an abutting sensor 11.

The automatic document feeder 40 is further provided, as sensors that input signals to the controller 100, with a document width sensor 13, a scanning entrance sensor 15, an appropriate feeding position sensor 8, and a home position sensor 6. The automatic document feeder 40 is still further provided, as sensors that input signals to the controller 100, with a trailing end detection sensor 301.

The automatic document feeder 40 is provided, as actuators that is controlled and driven by signals output from the controller 100, a second scanning unit 25, a pick-up motor 101, a feed motor 102, a scanning motor 103, a discharging motor 104, and a bottom plate uplifting motor 105.

The image forming apparatus main body 70a is provided with a main control unit 111 that controls the image forming apparatus main body 70a and an operating unit 108 that performs input operations of various kinds and instructs operations. The controller 100 and the main control unit 111 are connected via an I/F 107 and configured to mutually give and receive data including control signals.

Here, the registration sensor 17 is arranged between the scanning entrance roller 16 and the scanning roller 19 in the conveying path. The discharging sensor 24 is arranged between the scanning exit roller 23 and the second scanning unit 25 in the conveying path. The abutting sensor 11 is arranged at a position nearest, at an upstream side in the document conveying direction, to the pull-out roller 12 in the conveying path.

The document width sensor 13 is arranged between the pull-out roller 12 and the intermediate roller 14 in the conveying path, and the scanning entrance sensor 15 is arranged between the intermediate roller 14 and the scanning entrance roller 16 in the conveying path.

The trailing end detection sensor 301 is arranged at an upstream side of the abutting sensor 11 in the conveying path. Specifically, the trailing end detection sensor 301 is arranged at the uppermost stream side in the document conveying direction among the registration sensor 17, the discharging sensor 24, the abutting sensor 11, the document width sensor 13, and the scanning entrance sensor 15.

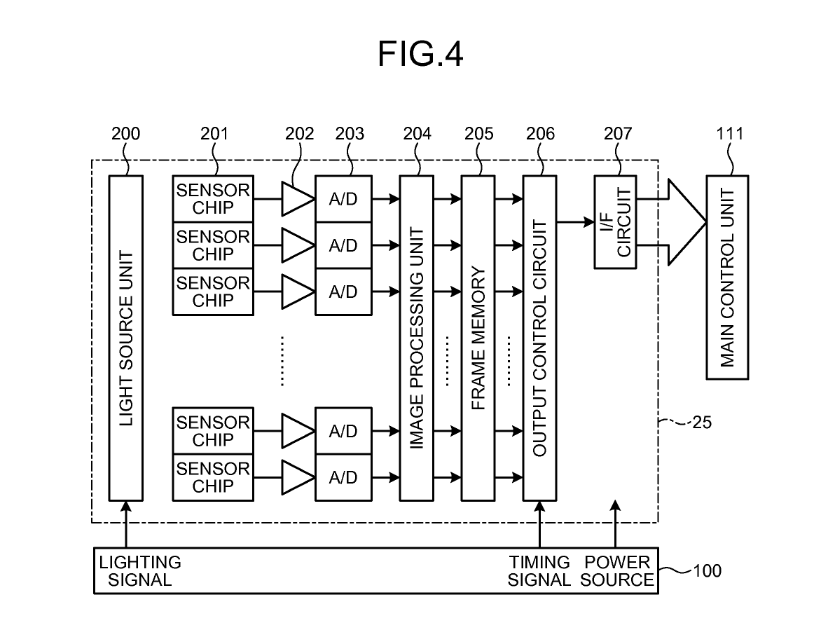

FIG. 4 is a block diagram of a configuration of the image scanning unit of the automatic document feeder according to the first embodiment.

As shown in FIG. 4, the second scanning unit 25 is provided with a light source unit 200 that irradiates the document with light based on a lighting signal from the controller 100, a plurality of sensor chips 201 that receive a reflection light from the document, and a plurality of amplifiers 202 that amplify signals output respectively from the sensor chips 201.

The second scanning unit 25 is provided with A/Ds 203 that each convert the amplified signal from an analogue signal to a digital signal, an image processing unit 204 that performs an image processing on the digital-converted signal, and a frame memory 205 that stores the signal on which the image processing is performed.

The second scanning unit 25 is provided with an output control circuit 206 that controls an output of the signal stored in the frame memory 205 based on a timing signal from the controller 100 and an I/F circuit 207 that outputs the signal from the output control circuit 206 to the main control unit 111. Here, an electric power is supplied from the controller 100 to the second scanning unit 25.

Here, a detailed configuration of the automatic document feeder 40 will be explained in accordance with the sequence until the document placed on the document table 2 is discharged to the discharge tray 29.

The document bundle 1 including a plurality of documents is placed on the document table 2 including a movable document table 3 in a state where the front surface looks upward. Next, a position in a width direction of the document bundle 1, i.e., a position in the direction perpendicular to the conveying direction is determined by a side guide not shown.

The fact that the document is placed on the document table 2 is detected by a set feeler 4 and the document set sensor 5 and a detection signal is output to the main control unit 111 of the image forming apparatus main body 70a via the I/F 107.

A rough length of the document in the conveying direction is detected by a document length detection sensors 30 and 31 provided on a surface of the document table 2. For the document length detection sensors 30 and 31, a reflective sensor that perform a detection without a contact with the document by using an optical device or a contact sensor of an actuator type capable of detecting even a single document can be used.

The document length detection sensors 30 and 31 are arranged so that whether the document is arranged lengthwise or widthwise can be determined.

The movable document table 3 is configured to move up and down by the bottom plate uplifting motor 105 in a direction shown by an arrow “a” and “b” in FIG. 2. When the fact that the document is placed on the document table 2 is detected by the set feeler 4 and the document set sensor 5, the controller 100 controls the bottom plate uplifting motor 105 to rotate clockwise to uplift the movable document table 3 so that the uppermost document of the document bundle 1 comes to be in contact with the pick-up roller 7. Hereinafter, a position where the uppermost document of the document bundle 1 comes to be in contact with the pick-up roller 7 is referred to as an appropriate feeding position.

The pick-up roller 7 operates by the pick-up motor 101 via a cam mechanism in a direction shown by an arrow “c” and “d” in FIG. 2 and is raised to the direction of the arrow “c” by being depressed by the documents on the uplifted movable document table 3, so that an upper limit in movement is detected by the appropriate feeding position sensor 8. The appropriate feeding position sensor 8 is provided to detect that the uppermost document of the document bundle 1 is kept at an appropriated height by the uplift of the movable document table 3.

When the operating unit 108 is operated, a print key is depressed after one of a duplex printing mode and a single side printing mode is specified, and a document feed signal is output from the main control unit 111 to the controller 100 via the I/F 107, the controller 100 is configured to cause the pick-up roller 7 to rotate by causing the feed motor 102 to rotate clockwise.

The pick-up roller 7 having started rotating is configured to pick up the uppermost document or several documents including the uppermost document on the document table 2.

Next, when the paper feeding belt 9 and the reverse roller 10 are driven in the clockwise direction due to the clockwise rotation of the feed motor 102, the paper feeding belt 9 guides the document to a feeding direction and the reverse roller 10 pushes out the document in a reverse direction of the feeding direction, so that the uppermost document and the other documents under the uppermost document of the document bundle 1 are separated and only the uppermost document is fed.

Specifically, the reverse roller 10 is in contact with the paper feeding belt 9 with a predetermined pressure and configured to rotate in an counterclockwise direction different from an original driving direction due to an action of a not shown torque limiter by following the rotation of the paper feeding belt 9 in a state of being in direct contact with the paper feeding belt 9 or in a state of being in contact with the paper feeding belt 9 via one document.

When two or more documents come in between the paper feeding belt 9 and the reverse roller 10, the reverse roller 10 is configured to rotate in the clockwise direction which is the original driving direction without following the paper feeding belt 9, function to push back residual documents, and prevent multiple documents from being fed.

After one document having been separated by the action of the paper feeding belt 9 and the reverse roller 10 is conveyed by the paper feeding belt 9, a leading end of the document is configured to be detected by the abutting sensor 11 and further conveyed to be in direct contact with the stopped pull-out roller 12.

Next, when the document having been conveyed by a predetermined distance from the position detected by the abutting sensor 11 comes to a state of being depressed onto the pull-out roller 12 with a predetermined amount of flexure, the feed motor 102 is configured to be stopped and thereby the driving of the paper feeding belt 9 is stopped.

On this occasion, the pick-up roller 7 is made to leave the upper surface of the document by causing the pick-up motor 101 to rotate, the leading end of the document is sandwiched by the pull-out rollers 12 by feeding the document only with a feeding force of the paper feeding belt 9, and thereby a layout for alignment of the leading end, i.e., what we call a skew correction is performed.

The pull-out roller 12 has functions of the skew correction and of conveying the document on which the skew correction is performed after separation to the intermediate roller 14, and is driven by a reverse rotation of the feed motor 102.

Here, though the pull-out roller 12 and the intermediate roller 14 are driven in the reverse rotation of the feed motor 102, the pick-up roller 7 and the paper feeding belt 9 are configured not to be driven.

The document width sensor 13 is configured by a plurality of photoelectric conversion elements, such as a contact image sensor called CIS, arranged in the direction perpendicular to the conveying direction of the document, and is configured to output a light reception level of a direct light radiated from a not shown radiation light source arranged at a facing part across the conveying path.

The controller 100 detects, when the document passes through the position of the document width sensor 13, a difference in level in the document width sensors 13 between a part where the light is blocked by the document and a part where the light is not blocked, and determines and notifies to the main control unit 111 the size in the width direction of the document conveyed by the pull-out roller 12.

The length in the conveying direction of the document is configured to be detected based on a motor pulse by scanning the leading end and the trailing end of the document by the abutting sensor 11. When the document is conveyed from the registration section C to the turn section D by the driving of the pull-out roller 12 and the intermediate roller 14, a conveying speed in the registration section C is set to be higher than that in the first scan conveying section E to shorten a processing time for feeding the document to the first scan conveying section E.

A control after the leading end of the document is detected by the scanning entrance sensor 15 differs depending on whether an operation mode is a nonstop mode or a stop mode.

In a nonstop mode, a speed reduction is started so that the document conveying speed is made equal to a scan conveying speed before the leading end of the document comes into a nip part of the scanning entrance roller 16 and the scanning motor 103 is driven at the same time to rotate clockwise to drive the scanning entrance roller 16, the scanning exit roller 23, and a CIS exit roller 27a.

After that, a gate signal indicating an effective image area of a first surface (document front surface) in a vertical scanning direction is transmitted to the main control unit 111 from a moment when the leading end of the document is detected by the registration sensor 17 and the leading end, detected based on a pulse count by the scanning motor 103, of the document reaches the scanning position 20 until the trailing end of the document passes over the scanning position 20.

In the stop mode, in contrast, the feed motor 102 is driven, after the leading end of the document is detected by the scanning entrance sensor 15, by a pulse count which is determined in advance to produce a predetermined amount of flexure after the document hits the nip part of the scanning entrance roller 16, the document is then stopped (hereinafter referred to as “registration stop”, too), and a registration stop signal is transmitted to the main control unit 111 via the I/F 107. Specifically, the position where the scanning entrance roller 16 is provided is a stop position where the document is stopped.

Then, when a scan start signal is received from the main control unit 111, the document in the registration stop is conveyed at an increased speeded so that a predetermined conveying speed is realized until the leading end reaches the scanning position 20.

After that, a gate signal indicating an effective image area of the first surface in the vertical scanning direction is transmitted to the main control unit 111 from a moment when the leading end of the document is detected by the registration sensor 17 and the leading end, detected based on the pulse count by the scanning motor 103, of the document reaches the scanning position 20 until the trailing end of the document passes over the scanning position 20.

When the operation mode is a single sided printing mode, the controller 100 conveys the document having passed through the first scan conveying section E to the discharging section G via the second scanning unit 25. On this occasion, when the leading end of the document is detected by the discharging sensor 24, the controller 100 drives the discharging motor 104 to rotate clockwise to cause the pair of discharging rollers 50 to rotate in the counterclockwise direction.

The controller 100 performs a pulse count of the discharging motor 104 after the discharging sensor 24 detects the leading end of the document and reduces the driving speed of the discharging motor 104 right before the trailing end of the document passes over the nip area of the pair of the discharging rollers 50, thereby preventing the document to be discharged on the discharge tray 29 from jumping out.

As explained, the document is temporarily stopped at the scanning entrance roller 16 once the leading end of the document is detected by the scanning entrance sensor 15 in the stop mode, and the document is conveyed without a temporary stop in the nonstop mode.

When the operation mode is a duplex printing mode, the controller 100 performs a pulse count of the scanning motor 103 after the leading end of the document is detected by the discharging sensor 24 and outputs a gate signal indicating an effective image area in the vertical scanning direction to the second scanning unit 25 at a moment when the leading end of the document reaches the second scanning unit 25. The gate signal is continuously output until the trailing end of the document passes over the second scanning unit 25.

Here, an antifoulant coating processing is performed on a surface of the second scanning unit 25 to prevent a sticky foreign material adhering to the document from being transferred. A second scanning roller 26 is arranged in a manner of facing the second scanning unit 25, depresses the document passing through the second scanning unit 25 onto the second scanning unit 25 to suppress a float of the document in the second scanning unit 25, and also functions as a white reference unit that obtains shading data in the second scanning unit 25 and performs a shading correction. Specifically, the second scanning roller 26 doubles as a white color shading member.

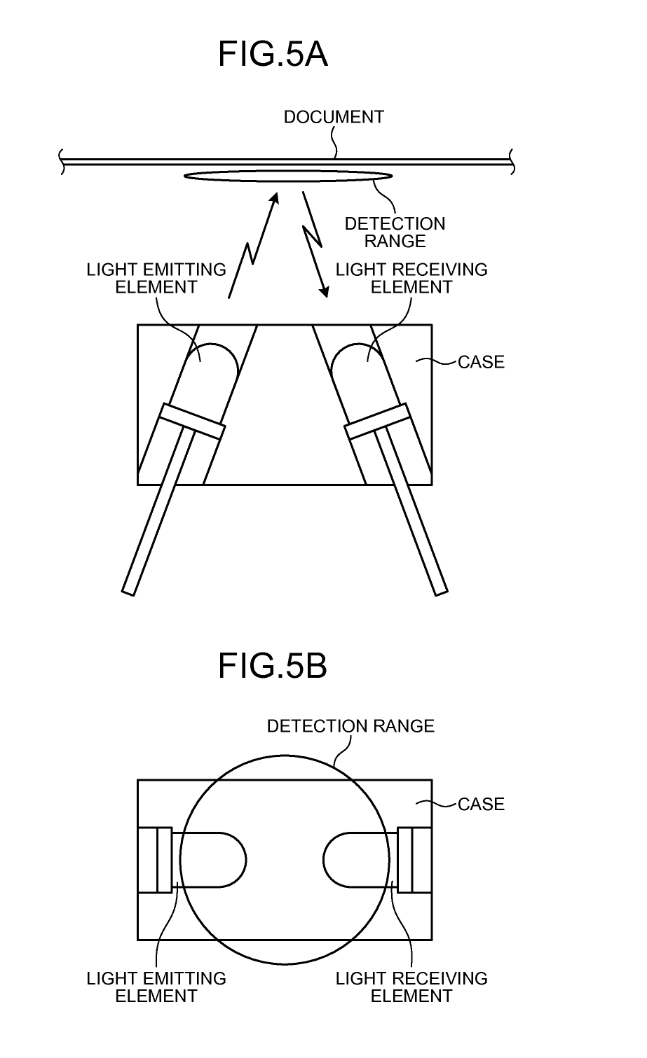

The trailing end detection sensor 301, the abutting sensor 11, the document width sensor 13, the scanning entrance sensor 15, the registration sensor 17, and the discharging sensor 24 are formed by reflective optical sensors. A reflective optical sensor has a structure of housing a light emitting element and a light receiving element in a case and has a circular detection range as shown in FIGS. 5A and 5B. The reflective optical sensor is configured to detect that the document is present in the detection range of the reflective optical sensor when a light is emitted from the light emitting element and the light reflected on the document is received by the light receiving element.

The trailing end detection sensor 301 constitutes an upstream document detecting unit according to the present invention and the abutting sensor 11, the document width sensor 13, the scanning entrance sensor 15, the registration sensor 17, and discharging sensor 24 constitute document detecting units according to the present invention. In the explanation below, the abutting sensor 11, the document width sensor 13, the scanning entrance sensor 15, and the registration sensor 17 are also collectively referred to as the document detecting units. The state where the light receiving element of the reflective optical sensor receives the light in response to the reflection on the document is referred to as the reflective optical sensor's being ON and the state where the light receiving element of the reflective optical sensor does not receive the light is referred to as the reflective optical sensor's being OFF.

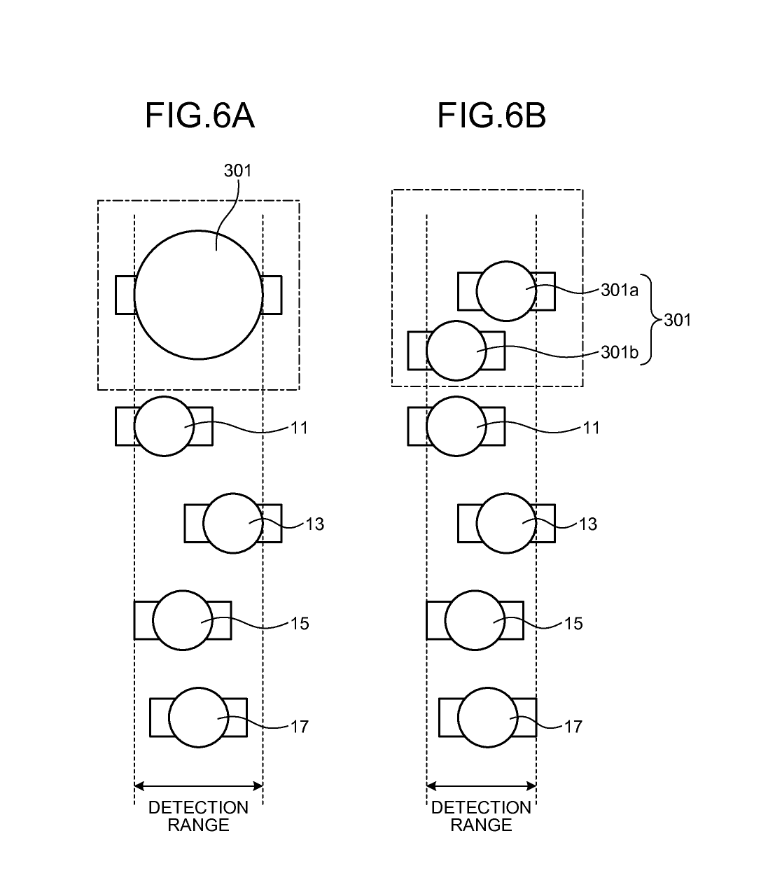

As shown in FIG. 6A, the trailing end detection sensor 301 whose detection range is wide is arranged at the uppermost stream in the document conveying direction and the abutting sensor 11, the document width sensor 13, the scanning entrance sensor 15, and the registration sensor 17 as the document detecting units are arranged at a downstream side within the detection range of the trailing end detection sensor 301 so that all detection ranges of these sensors are included within the detection range of the trailing end detection sensor 301 in the present embodiment.

To detect a hole on the document, for example, the controller 100 counts a specified document feed rate (pulse count in the case of a stepping motor) of the document conveying unit (feed motor 102, for example) after the trailing end detection sensor 301 is changed from ON (document is detected) to OFF (document is not detected), determines that not the trailing end of the document but a hole on the document is detected when the trailing end detection sensor 301 detects the document and becomes ON during the counting, and continues conveying the document until the trailing end detection sensor 301 becomes OFF again. Here, the hole on the document includes not only a punched hole formed on the document but also a hole produced by being torn.

On the other hand, when the trailing end detection sensor 301 is not changed to ON even by conveying the document by a specified amount after the trailing end detection sensor 301 first becomes OFF, the controller 100 is configured to determine that the trailing end of the document is detected and start a next operation (next document feeding, for example).

In other words, the controller 100 conveys the document by a specified amount after the trailing end detection sensor 301 is changed from ON to OFF, determines that there is a hole on the document when the trailing end detection sensor 301 is changed again to ON, conveys the document by a specified amount after the trailing end detection sensor 301 is changed from ON to OFF, and determines that there is no hole on the document when the trailing end detection sensor 301 remains OFF.

The controller 100 is configured to determine whether or not to perform a determination on the presence of a hole on the document by using the document detecting units at a downstream side depending on the result of the determination on the hole presence on the document by using the trailing end detection sensor 301.

More specifically, when determining that there is no hole on the document based on the detection result of the trailing end detection sensor 301, the controller 100 is configured to determine that the trailing end of the document is detected and start a next operation promptly right at the moment when the document detecting unit is changed from ON to OFF without performing the determination on the hole presence on the document by using any sensors as the document detecting units at a downstream side.

Since the controller 100 thus does not perform the determination on the hole presence on the document by the document detecting units at a downstream side from the trailing end detection sensor 301 when determining that there is no hole on the document based on the detection result of the trailing end detection sensor 301, an extra processing time required for the determination on the hole presence on the document by the document detecting units is eliminated, thereby enabling a next operation (a next document feeding, for example) to be performed promptly.

In contrast, when determining that there is a hole on the document based on the detection result of the trailing end detection sensor 301, the controller 100 is configured to perform the same determination on the hole presence on the document as the determination by using the trailing end detection sensor 301, based on detection results of all the document detecting units at a downstream side.

In other words, when determining that there is a hole on the document based on the detection result of the trailing end detection sensor 301, the controller 100 is configured to determine the hole presence on the document based on whether or not a signal of each document detecting unit is changed again to ON during a period of conveying the document by a specified amount after a signal of each document detecting unit is changed from ON to OFF in each of all the document detecting units (the abutting sensor 11, the document width sensor 13, the scanning entrance sensor 15, and the registration sensor 17) at a downstream side.

As explained, since a processing time for detecting a hole by each document detecting unit becomes unnecessary when there is no hole on the document and a next document feeding is promptly performed by changing the operation of the controller 100 depending on the result of the determination on the hole presence on the document using the trailing end detection sensor 301, there is no chance that an interval between documents becomes extended.

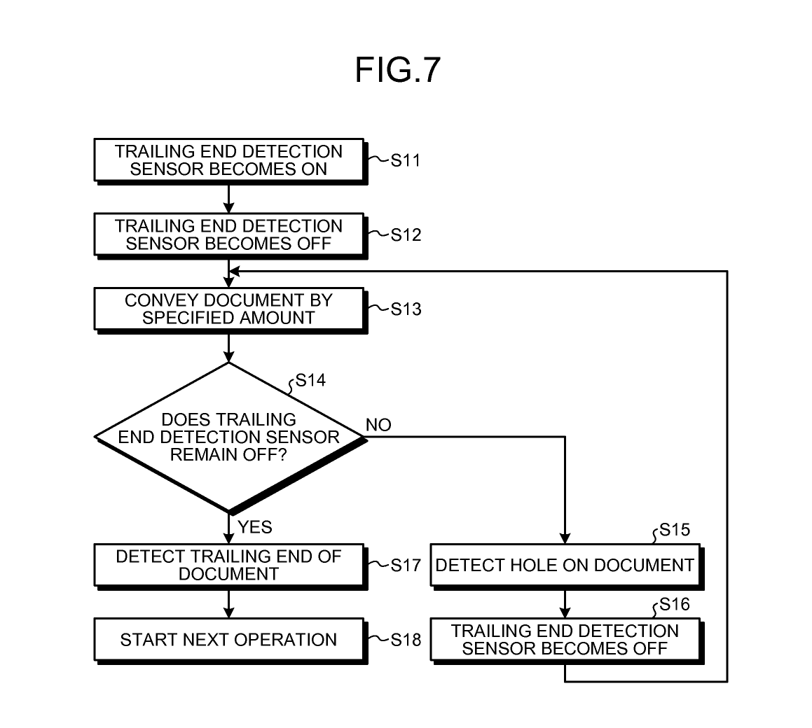

Next, the operation will be explained. As shown in FIG. 7, when the trailing end detection sensor 301 becomes ON (step S11) and then OFF (step S12), the controller 100 conveys the document by a specified amount (step S13).

The controller 100 then determines whether the trailing end detection sensor 301 remains OFF (step S14), determines that the trailing end of the document is detected (step S17) when determining that the trailing end detection sensor 301 remains OFF (“Yes” at step S14), and starts a next operation, a next document feeding, for example (step S18).

On the other hand, when determining that the trailing end detection sensor 301 does not remain OFF and is changed to ON at step S14 (“No” at step S14), the controller 100 determines that a hole on the document is detected (step S15) and again executes step S13 after the trailing end detection sensor 301 then becomes OFF (step S16).

When it is determined that a hole on the document is detected at step S15, the processing at steps S11 to S18 will be performed by treating in series, as a monitoring target instead of the trailing end detection sensor 301, detection signals of the abutting sensor 11, the document width sensor 13, the scanning entrance sensor 15, the registration sensor 17, and the discharging sensor 24, which are the document detecting units.

As shown in FIG. 6B, the trailing end detection sensor 301 may be configured not by one reflective optical sensor whose detection range is wide but by a first trailing end detection sensor 301a and a second trailing end detection sensor 301b each as a reflective optical sensor whose detection range is narrower, and the first trailing end detection sensor 301a and the second trailing end detection sensor 301b may be arranged by mutually being displaced in the document width direction (direction perpendicular to the document conveying direction) so that respective detection ranges partially overlap with each other.

In FIG. 6B, the first trailing end detection sensor 301a, the second trailing end detection sensor 301b, and the document detecting units are arranged so that detection ranges of all the document detecting units at a downstream side are included within a combined detection range of the first trailing end detection sensor 301a and the second trailing end detection sensor 301b.

Since the first trailing end detection sensor 301a and the second trailing end detection sensor 301b enable obtaining the trailing end detection sensor 301 whose detection range is wide in this case, it is possible for the controller 100 to execute the operation shown in the flowchart in FIG. 7 based on the result of the determination of this trailing end detection sensor 301, similarly to the configuration shown in FIG. 6A. The trailing end detection sensor 301 is not limited to the configuration exemplified in FIG. 65 and may be configured by two or more reflective optical sensors.

As explained so far, the automatic document feeder 40 according to the present embodiment is provided with the document table 2 on which documents are stacked; a plurality of rollers each as a conveying unit that separates one from the others of the documents stacked on the document table 2 and conveys the one document to the scanning position through the conveying path; the abutting sensor 11, the document width sensor 13, the scanning entrance sensor 15, the registration sensor 17, and the discharging sensor 24 as a plurality of document detecting units that are arranged in the conveying path and detect the document; the trailing end detection sensor 301 as an upstream document detecting unit that is arranged in the conveying path at an upstream side in the document conveying direction among any of the plurality of document detecting units and detects the document; and the controller 100 as a determining unit that determines a passage of the trailing end of the document at positions where the document detecting units and the trailing end detection sensor 301 are provided and determines a presence of a hole on the document based on detection results of the document detecting units and the trailing end detection sensor 301, the detection range of the trailing end detection sensor 301 is set to be wider than any detection ranges of the plurality of document detecting units, the trailing end detection sensor 301 and the plurality of document detecting units are arranged each other so that all the detection ranges of the plurality of document detecting units are included within the detection range of the trailing end detection sensor 301 in the direction perpendicular to the document conveying direction, and the controller 100 only performs the determination on the passage of the trailing end of the document without performing the determination on the hole presence on the document based on detection results of the document detecting units when determining that there is no hole on the document based on the detection result of the trailing end detection sensor 301.

Since the processing time required for the hole determination in the document detecting units becomes unnecessary when there is no hole on the document with this configuration, it is possible to reduce the processing time required for determining the trailing end of the document and a hole on the document and shorten an interval in conveying documents.

The image scanning device 80 according to the present embodiment is provided with the automatic document feeder 40.

Since the processing time required for the hole determination in the document detecting units when there is no hole on the document becomes unnecessary in the image scanning device 80 provided with the automatic document feeder 40 with this configuration, it is possible to reduce the processing time required for the determination on the trailing end of the document and a hole on the document and shorten an interval in conveying documents.

The image forming apparatus 70 according to the present embodiment is provided with the automatic document feeder 40.

Since the processing time required for the hole determination in the document detecting units when there is no hole on the document becomes unnecessary in the image forming apparatus 70 provided with the automatic document feeder 40 with this configuration, it is possible to reduce the processing time required for the determination on the trailing end of the document and a hole on the document and shorten an interval in conveying documents.

### Second Embodiment

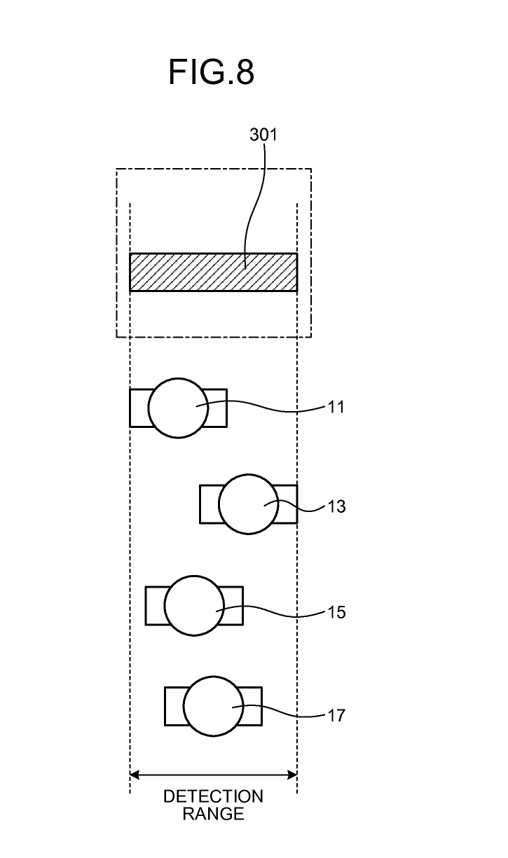

As shown in FIG. 8, the trailing end detection sensor 301 is configured by a line sensor, and the trailing end detection sensor 301 and the document detecting units at a downstream side are arranged so that detection ranges of all the document detecting units are included within the detection range of the trailing end detection sensor 301 in the document width direction (direction perpendicular to the document conveying direction) in the present embodiment. The line sensor is configured by arraying a plurality of image capturing elements in the document width direction.

Since the trailing end detection sensor 301 is configured by a line sensor and thereby a hole part on the document is recognized as an “omission” in an output signal of the trailing end detection sensor 301 in the present embodiment, it is possible to determine that there is a hole on the document.

Therefore, it is not necessary, for determining the presence of a hole on the document, to convey the document by a specified amount after a detection signal of the trailing end detection sensor 301 is changed from ON to OFF and to determine whether or not the detection signal of the trailing end detection sensor 301 again becomes ON during the conveyance of the document by the specified amount.

In the present embodiment, the controller 100 is configured to determine that the trailing end of the document is detected when each of all the document detecting units at a downstream side is changed from ON to OFF in the first detection in the case of determining that there is no hole on the document based on the detection result of the trailing end detection sensor 301 formed by the line sensor.

Specifically, the controller 100 is configured to determine that the trailing end of the document is detected when the change from ON to OFF is present in the first detection in each of all the document detecting units at a downstream side in the case of determining that there is no hole on the document by using the trailing end detection sensor 301, thereby enabling omitting the process of conveying the document by a specified amount after the document detecting units are changed from ON to OFF in the first detection and determining the hole presence on the document based on whether or not the document detecting units are again changed to ON.

The controller 100 stores the position of the hole from the document set reference position on the document table 2 in the document width direction (direction perpendicular to the document conveying direction) and the number of holes when determining that there is a hole on the document based on the detection result of the trailing end detection sensor 301 formed by the line sensor.

Then, when comparing the stored hole position on the document with positions and detection ranges of any document detecting units at a downstream side and determining that the hole on the document is present within the detection range of the document detecting unit at a downstream side, in other words, when the hole position corresponds to the position of the document detection unit in the width direction of the document, the controller 100 is configured not to determine that the trailing end of the document is detected even when the document detecting unit is changed from ON to OFF for the stored number of holes, and configured to determine that the trailing end of the document is detected when the document detecting unit is changed from ON to OFF in “the number of holes+1” th detection.

By performing the operation explained above by using the document detecting units and the trailing end detection sensor 301 formed by the line sensor, it is possible for the controller 100 to accurately determine the passage of the trailing end of the document based on the detection results of the trailing end detection sensor 301 and the document detecting units at a downstream side irrespective of the presence of a hole on the document.

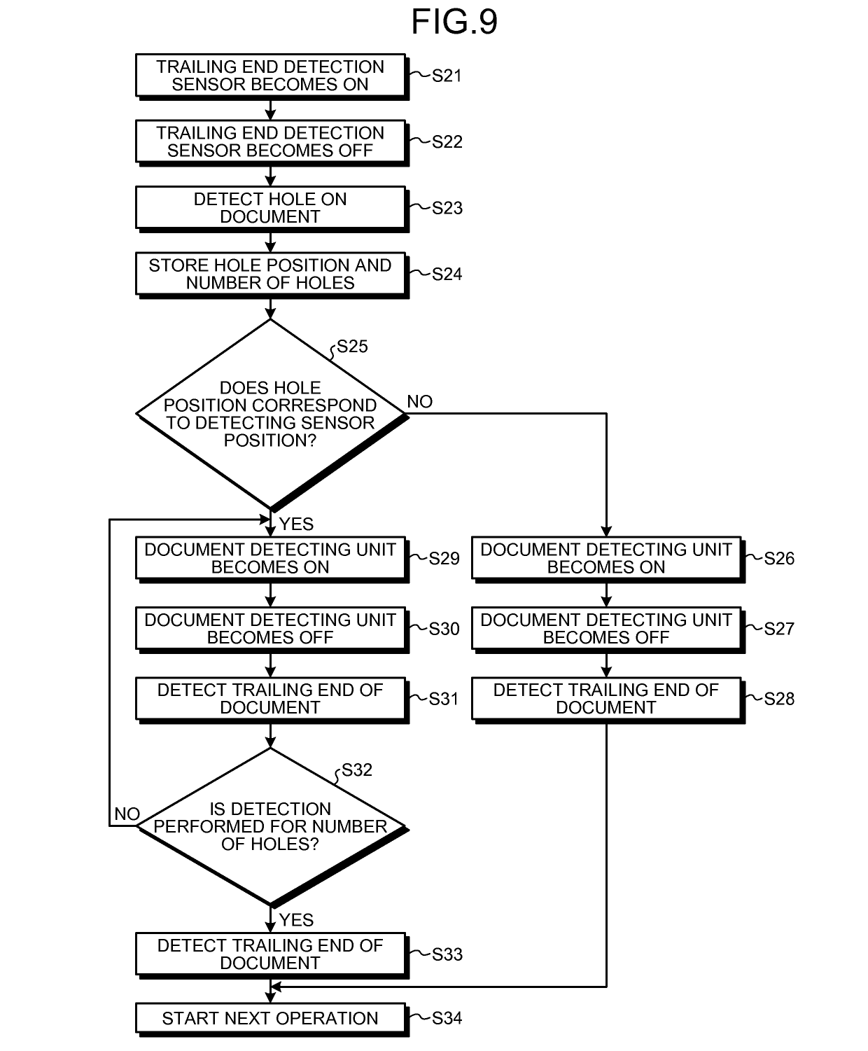

Next, the operation will be explained. As shown in FIG. 9, when the trailing end detection sensor 301 formed by the line sensor becomes ON (step S21) and then OFF (step S22), the controller 100 determines that a hole on the document is detected (step S23) and stores the position and the number of holes (step S24).

Next, the controller 100 determines whether or not the hole position corresponds to the position of the document detecting unit in the width direction (step S25), when determining that the position does not correspond (“No” at step S25), determines when the document detecting unit at a downstream side becomes ON (step S26) and then OFF (step S27), that the trailing end of the document is detected (step S28), and starts a next operation (step S34).

On the other hand, when determining that the position corresponds at step S25 (“Yes” at step S25), the controller 100 determines, when the document detecting unit at a downstream side becomes ON (step S29) and then OFF (step S30), that the trailing end of the document is detected (step S31).

After step S31, the controller 100 then determines whether or not the detection for the number of holes is performed (step S32), returns to step S29 when determining that the detection for the number of holes is not performed (“No” at step S32), determines that the trailing end of the document is detected (step S33) when determining that the detection for the number of holes is performed (“Yes” at step S32), and starts a next operation (step S34).

As explained so far, the trailing end detection sensor 301 in the automatic document feeder 40 according to the present embodiment is configured by the line sensor including a plurality of image capturing elements arrayed in the direction perpendicular to the document conveying direction.

Since a hole part on the document is recognized as an “omission” in the output signal of the trailing end detection sensor 301 by realizing the trailing end detection sensor 301 by the line sensor in this configuration, it is possible to eliminate a necessity of monitoring a change in detection signal while conveying the document by a specified amount and to determine promptly that there is a hole one the document.

In the automatic document feeder 40 according to the present embodiment, the controller 100 stores, when determining that there is a hole on the document based on the detection result of the trailing end detection sensor 301, the position of the hole in the direction perpendicular to the document conveying direction and cancels out detection results for the stored number of holes among the detection results of the document detecting unit which corresponds to the stored hole position in the direction perpendicular to the document conveying direction.

With this configuration, it is possible to accurately determine the passage of the trailing end of the document based on the detection results of the trailing end detection sensor 301 the document detecting units at a downstream side irrespective of the hole presence on the document.

### Third Embodiment

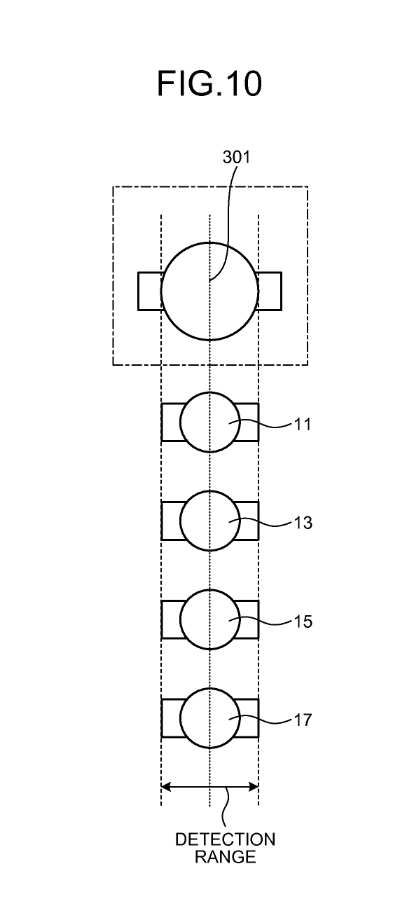

FIG. 10 shows a situation of arranging the trailing end detection sensor 301 and the document detecting units so that a center position of the detection range of the trailing end detection sensor 301 and center positions of respective detection ranges of the document detecting units at a downstream side in the document width direction (direction perpendicular to the document conveying direction) are in the same straight line.

In FIG. 10, a center position in the document width direction of the detection range of the trailing end detection sensor 301 arranged at the uppermost stream in the document conveying direction and center positions in the document width direction of the detection ranges of all the document detecting units at a downstream side are arranged in the same straight line and the detection range of the trailing end detection sensor 301 is wider than the detection ranges of all the document detecting units at a downstream side.

This configuration enables, even in the case where the trailing end detection sensor 301 is formed by a reflective optical sensor, detecting, irrespective of the presence of a hole on the document, the trailing end of the document accurately in the document detecting units at a downstream side from the trailing end detection sensor 301, similarly to the case where the trailing end detection sensor 301 is formed by the line sensor; downsizing; and reducing the cost.

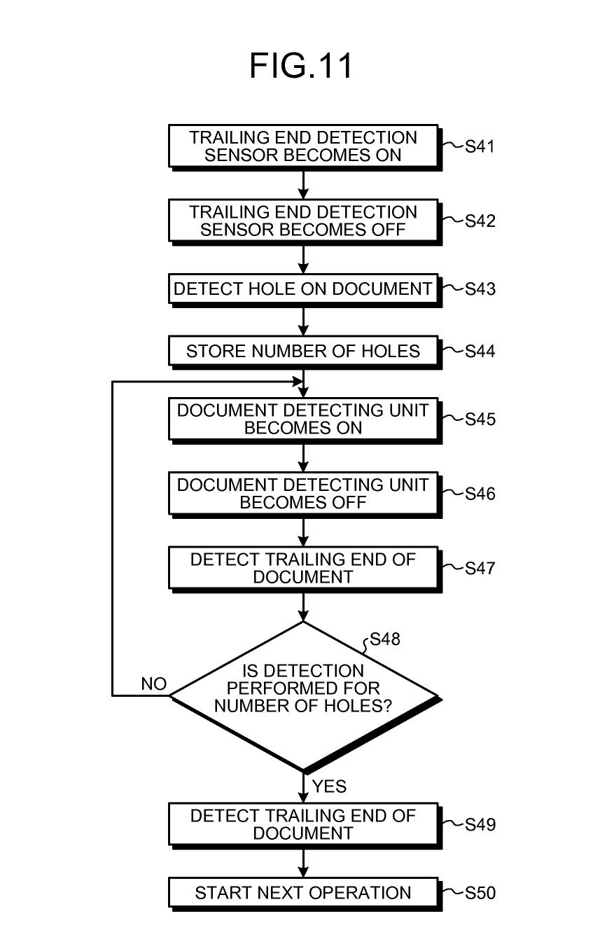

Next, the operation after detecting a hole on the document will be explained. As shown in FIG. 11, when the trailing end detection sensor 301 becomes ON (step S41) and then OFF (step S42), the controller 100 determines that a hole on the document is detected (step S43) and stores the number of holes (step S44).

When the document detecting units at a downstream side from the trailing end detection sensor 301 become ON (step S45) and then OFF (step S46), the controller 100 determines that the trailing end of the document is detected (step S47).

The controller 100 then determines whether or not the detection for the number of holes is performed after step S47 (step S48), returns to step S45 when determining that the detection for the number of holes is not performed (“No” at step S48), determines when determining that the detection for the number of holes is performed (“Yes” at step S48) that the trailing end of the document is detected (step S49), and starts a next operation (step S50).

As explained so far, the trailing end detection sensor 301 and the document detecting units in the automatic document feeder 40 according to the present embodiment are arranged so that respective centers of the detection ranges of the trailing end detection sensor 301 and the document detecting units are in the same straight line in the direction perpendicular to the document conveying direction.

This configuration enables, even in the case where the trailing end detection sensor 301 is formed by a reflective optical sensor, detecting, irrespective of the presence of a hole on the document, the trailing end of the document accurately in the document detecting units, similarly to the case where the trailing end detection sensor 301 is formed by a line sensor; downsizing; and reducing the cost.

### Fourth Embodiment

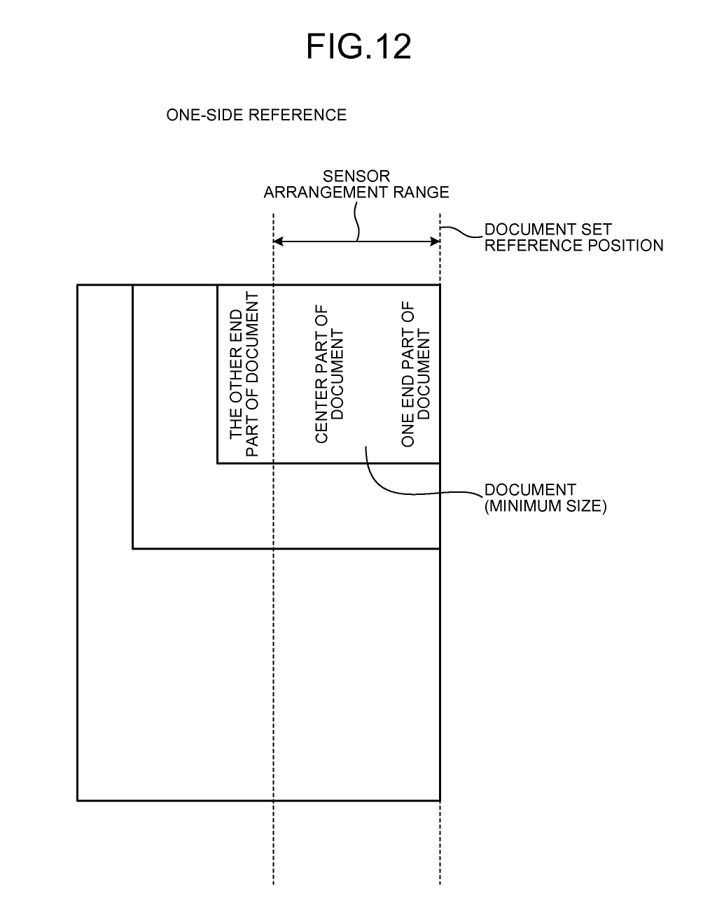

As shown in FIG. 12, the document table 2 includes a document set reference position at which one end part of the document in the direction perpendicular to the document conveying direction is arranged, and the trailing end detection sensor 301 and the document detecting units are arranged so that the detection ranges of the trailing end detection sensor 301 and the document detecting units in the direction perpendicular to the document conveying direction fall between the document set reference position and the other end part of the document having a minimum size which can be stacked on the document table 2 in the direction perpendicular to the document conveying direction in the present embodiment.

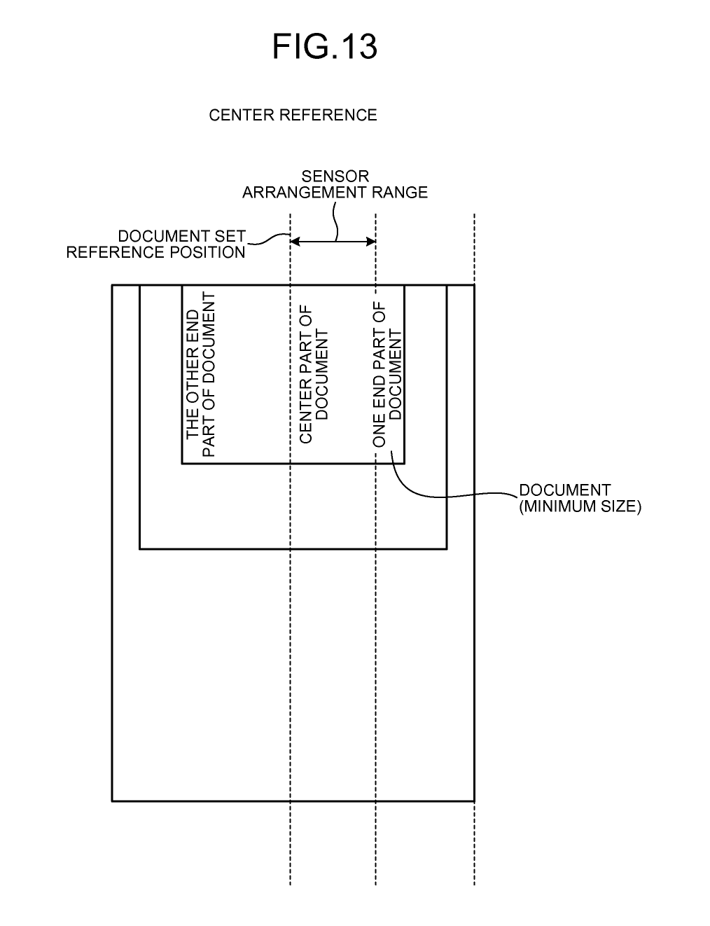

As shown in FIG. 13, the document table 2 includes another document set reference position at which a center part of the document is arranged in the direction perpendicular to the document conveying direction, and the trailing end detection sensor 301 and the document detecting units are arranged so that the detection ranges of the trailing end detection sensor 301 and the document detecting units in the direction perpendicular to the document conveying direction fall between the document set reference position and one end part of the document having a minimum size which can be stacked on the document table 2 in the direction perpendicular to the document conveying direction in the present embodiment.

Specifically, the sensor arrangement ranges shown in FIGS. 12 and 13 are set as ranges which allow detecting the document of the minimum size, and the trailing end detection sensor 301 and the document detecting units are arranged in the sensor arrangement ranges.

This configuration enables the controller 100, with respect to documents of all sizes including the minimum size document which can be stacked on the document table 2, to determine the passage of the trailing end of the document at positions where the document detecting units and the trailing end detection sensor 301 are provided and determine the presence of a hole on the document.

According to the embodiments, it is possible to provide an automatic document feeder, an image scanning device, and an image forming apparatus capable of reducing a processing time required for a determination between a trailing end of a document and a hole on a document and of shortening an interval in conveying documents.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic document feeder, comprising:
a document stack unit on which documents are stacked;
a conveying unit configured to
separate a document from the documents stacked on the document stack unit, and
convey the document to a scanning position through a conveying path;
a plurality of document detecting units configured to detect the document, the document detecting units being arranged in the conveying path;
an upstream document detecting unit configured to detect the document, the upstream document detecting unit being arranged in the conveying path at an uppermost stream in a document conveying direction with respect to the document detecting units; and
a determining unit configured to determine a passage of a trailing end of the document at positions where the document detecting units and the upstream document detecting unit are provided and determine a presence of a hole on the document, based on results of detection by the document detecting units and the upstream document detecting unit, wherein
a detection range of the upstream document detecting unit is set to be wider than detection ranges of the document detecting units,
the upstream document detecting unit and the document detecting units are arranged so that all the detection ranges of the document detecting units are included in the detection range of the upstream document detecting unit in a direction perpendicular to the document conveying direction, and
the determining unit is configured to determine the passage of the trailing end of the document without determining the presence of the hole on the document when the determining unit determines that there is no hole on the document based on the detection result of the upstream document detecting unit.

2. The automatic document feeder according to claim 1, wherein the upstream document detecting unit includes a line sensor including a plurality of image capturing elements arrayed in a direction perpendicular to the document conveying direction.

3. The automatic document feeder according to claim 2, wherein the determining unit is configured to store position(s) and the number of hole(s) on the document in the direction perpendicular to the document conveying direction and cancel out detection results for the stored number of hole(s) among the detection results of the document detecting units whose position corresponds to the stored hole position in the direction perpendicular to the document conveying direction when the determining unit determines that there is at least one hole on the document based on the detection result of the upstream document detecting unit.

4. The automatic document feeder according to claim 1, wherein the upstream document detecting unit and the document detecting units are arranged so that centers of respective detection ranges of the upstream document detecting unit and the document detecting units are aligned in a same straight line in a direction perpendicular to the document conveying direction.

5. The automatic document feeder according to claim 1, wherein
the document stack unit includes a document set reference position at which one of one end part and a center part of the documents is arranged in a direction perpendicular to the document conveying direction, and
the upstream document detecting unit and the document detecting units are arranged so that the detection ranges in a direction perpendicular to the document conveying direction of the upstream document detecting unit and the document detecting units fall either between the document set reference position and the one end part of the documents of minimum size which can be stacked on the document stack unit or between the document set reference position and other end part of the documents of minimum size which can be stacked on the document stack unit in the direction perpendicular to the document conveying direction.

6. An image scanning device, comprising the automatic document feeder according to claim 1.

7. An image forming apparatus, comprising the automatic document feeder according to claim 1.
